(19) United States
(12) Patent Application Publication
(10) Pub. No.: US 2021/0324681 A1
(43) Pub. Date: Oct. 21, 2021

(54) Folding Ladder System

(71) Applicant: Byron Norman Ricketts, Sunrise, FL (US)

(72) Inventor: Byron Norman Ricketts, Sunrise, FL (US)

(21) Appl. No.: 16/854,794

(22) Filed: Apr. 21, 2020

(51) Int. Cl. E06C 7/08; E06C 1/18; E06C 1/12; E06C 7/14

(52) U.S. Cl. CPC E06C 7/08; E06C 7/14; E06C 1/125; E06C 1/18

(57) ABSTRACT

The Folding Ladder system is comprised of a square edge Double Sided Folding Step Ladder and a square edge Straight Folding Ladder. Both Ladders are collapsible and fold at each Step level which allows the Ladders to fold to a fraction of their normal size. The square overlapping Sections are unique to these ladders. They looks like regular ladders but on closer examination each Section collapse on the Section below which creates a stock up effect that cause the ladder to fold to about a quarter of its original size. The Double Sided Folding Step Ladder has Angled Uprights at the Bottom Section which gives it a wider base which prevent side tip over. The Top Step of both Ladders is not a Step. It is a storage compartment with rounded top not suitable for standing. An access door in the top of the Compartment give access where small tools and parts can be put away safely, without falling if the occupant moves the Ladder.

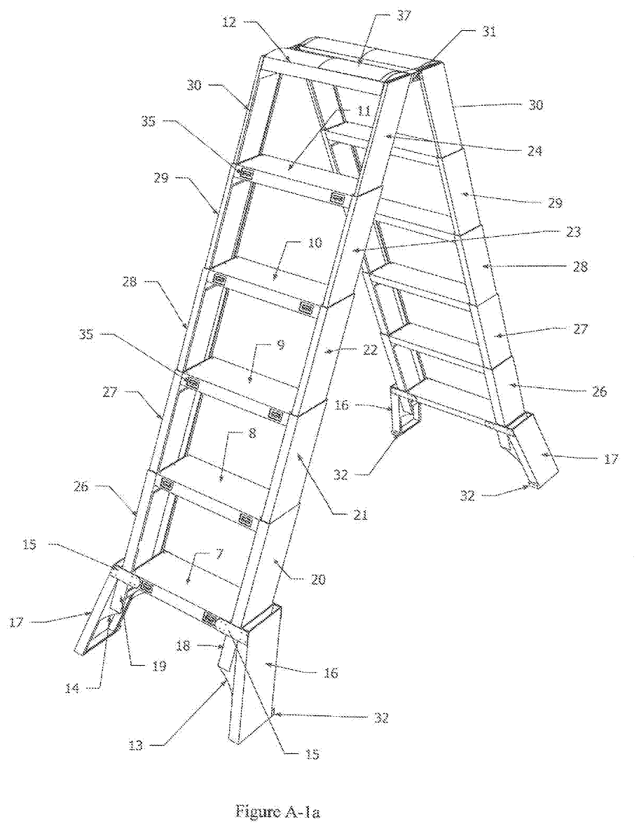

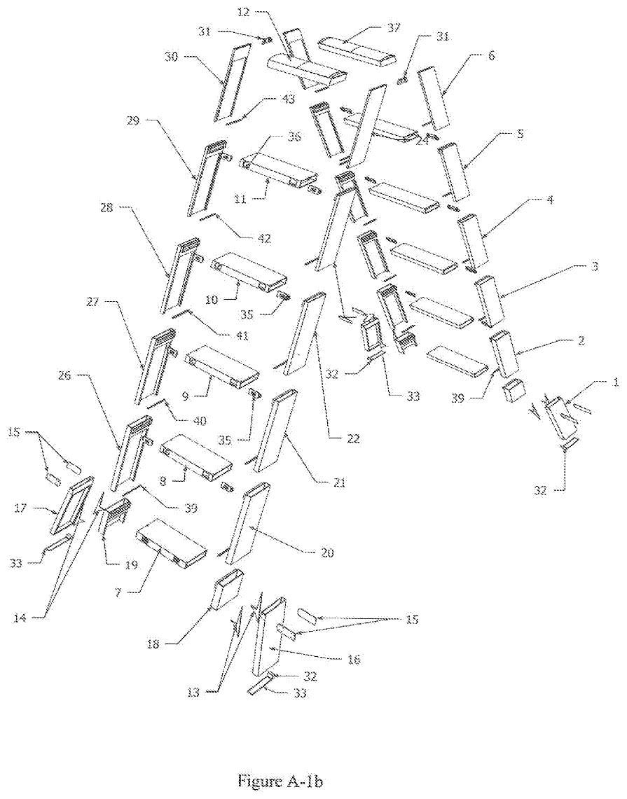

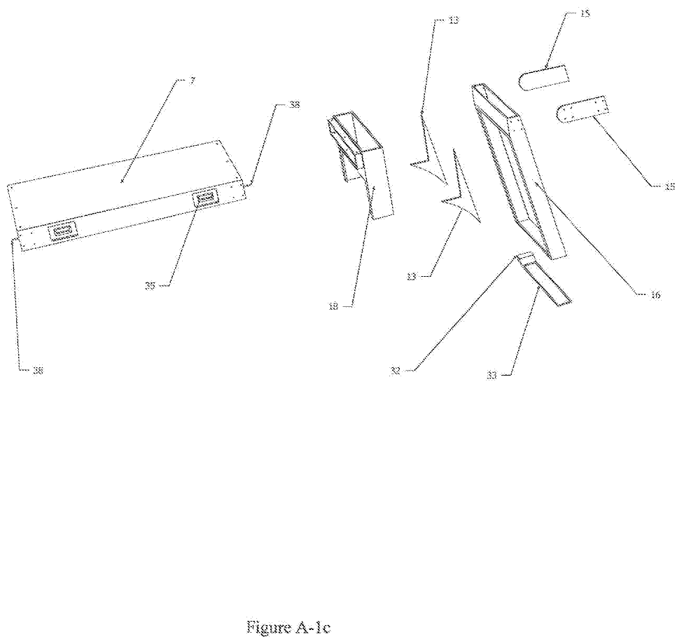

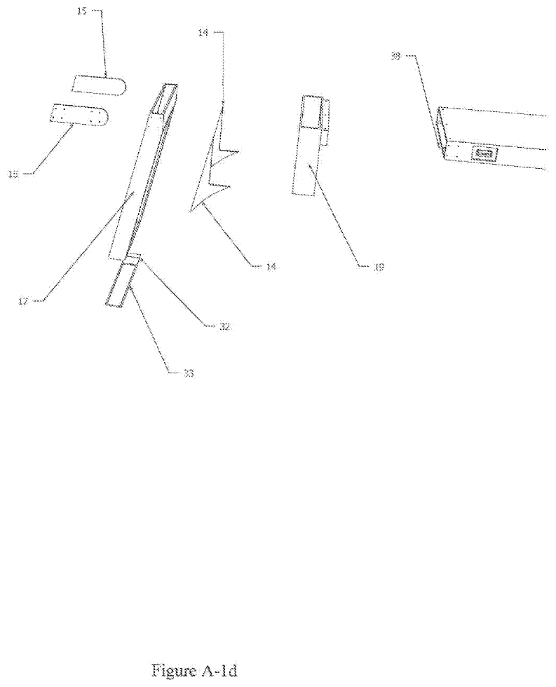

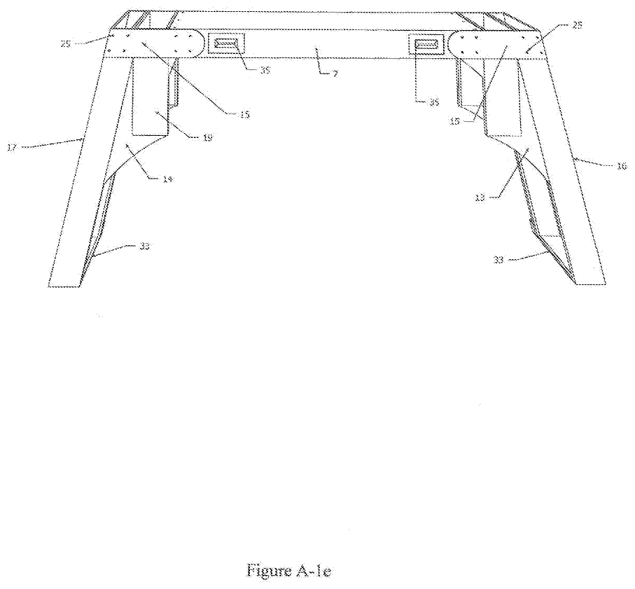

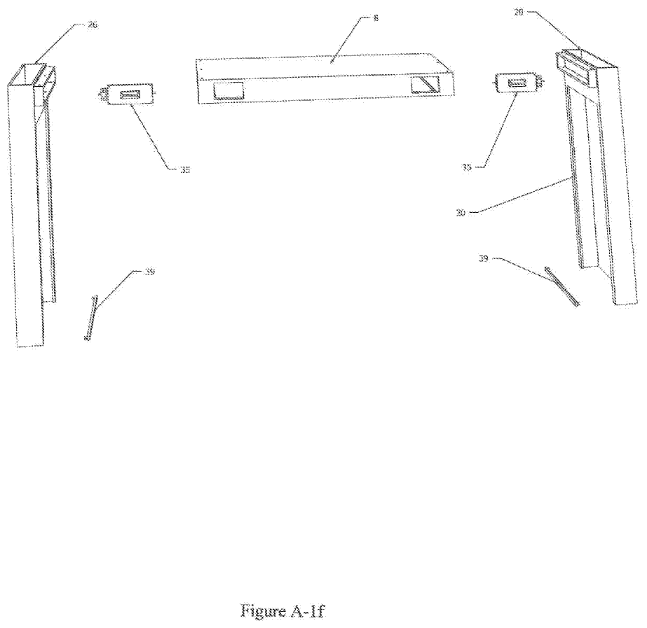

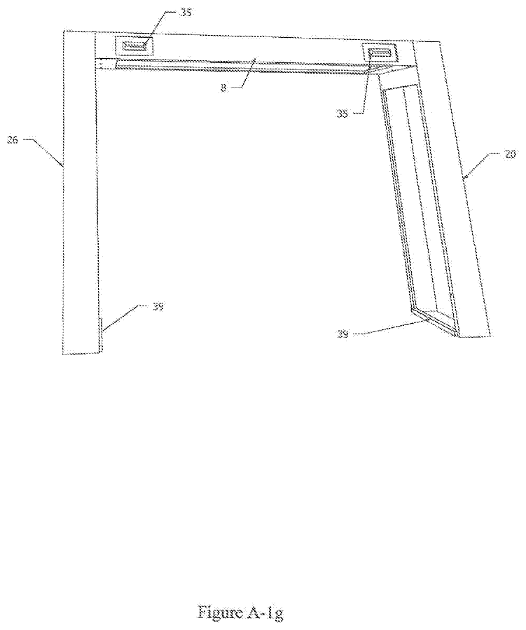

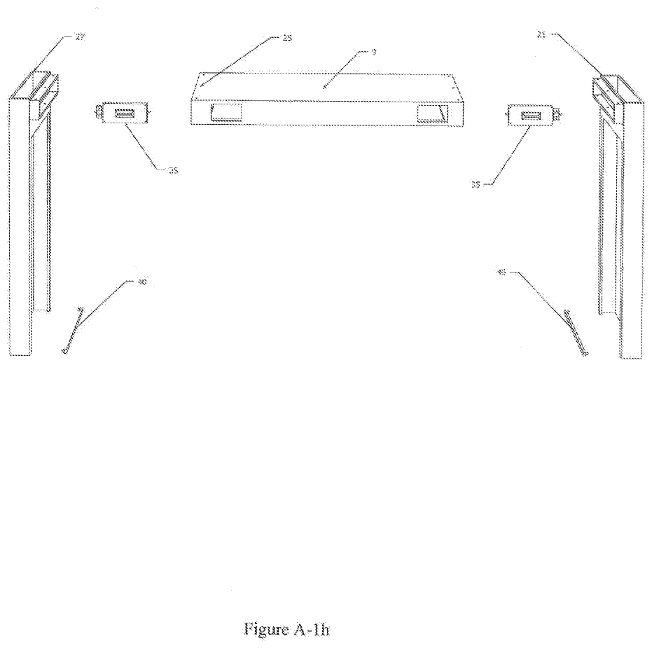

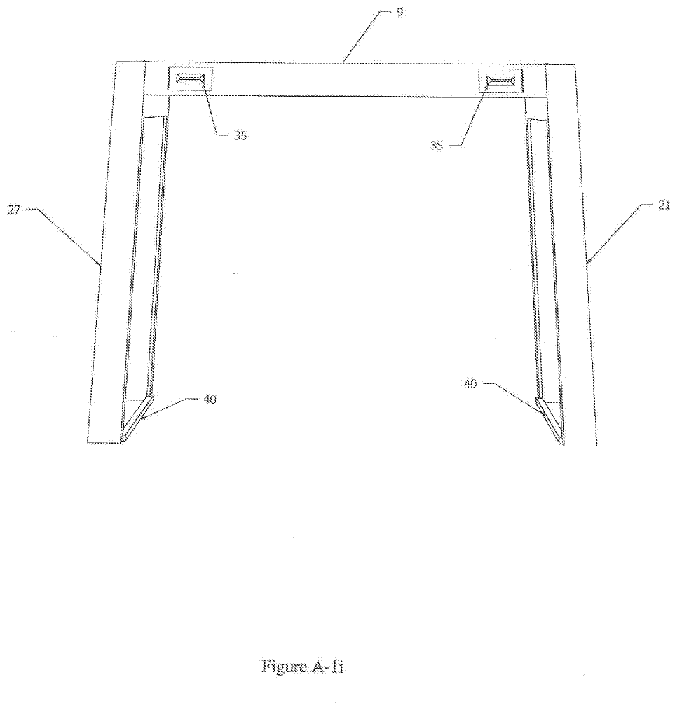

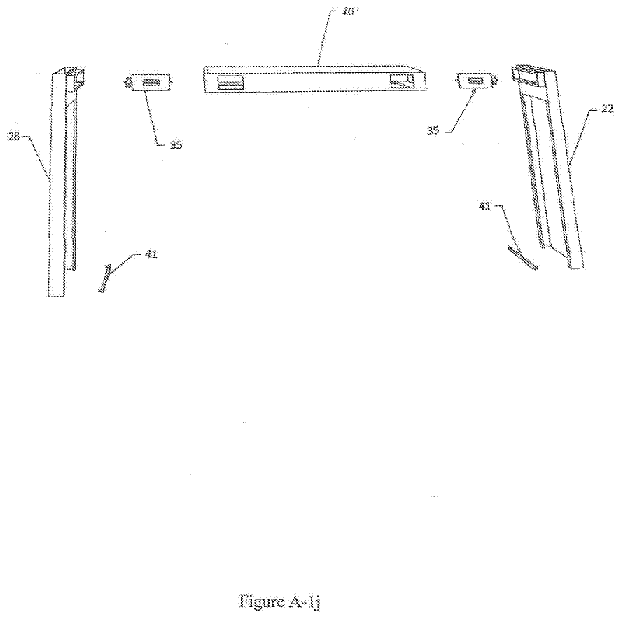

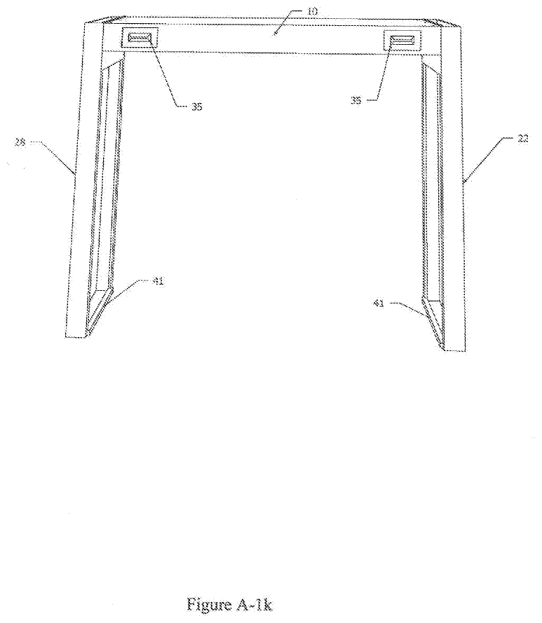

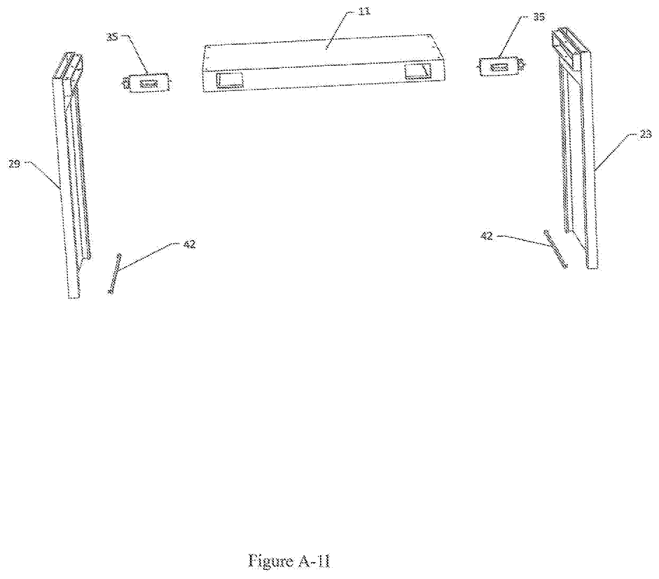

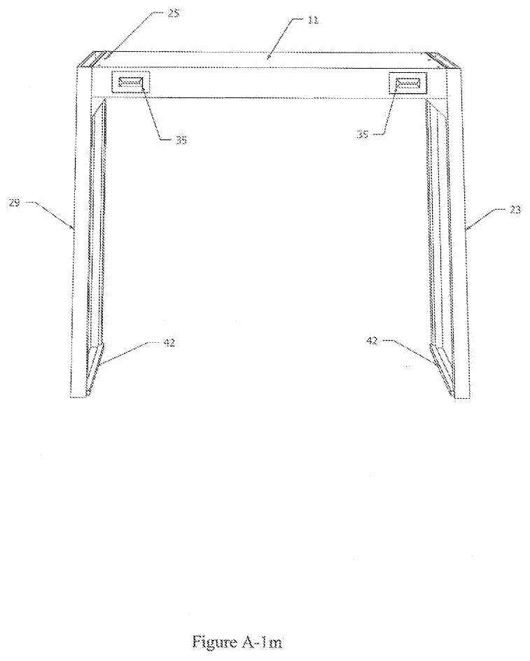

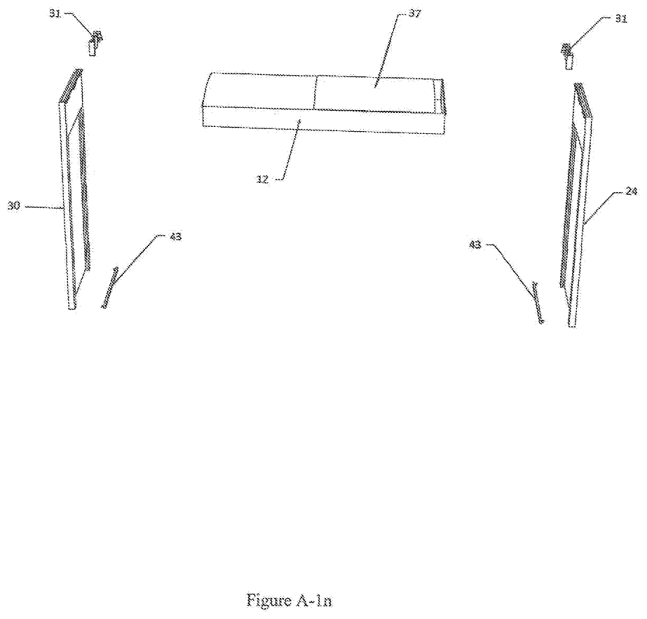

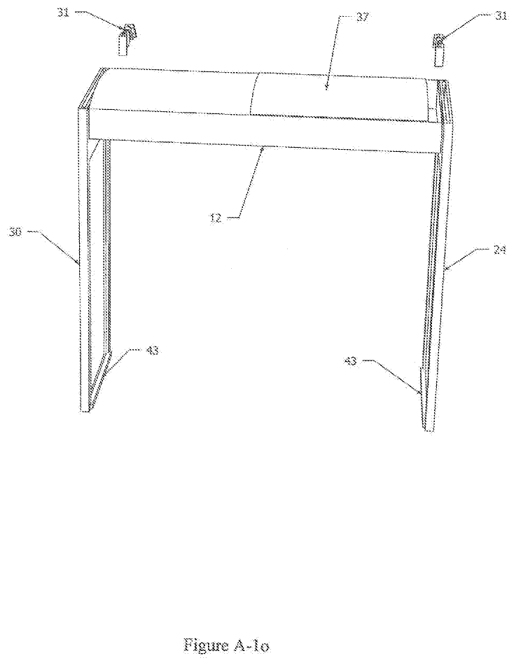

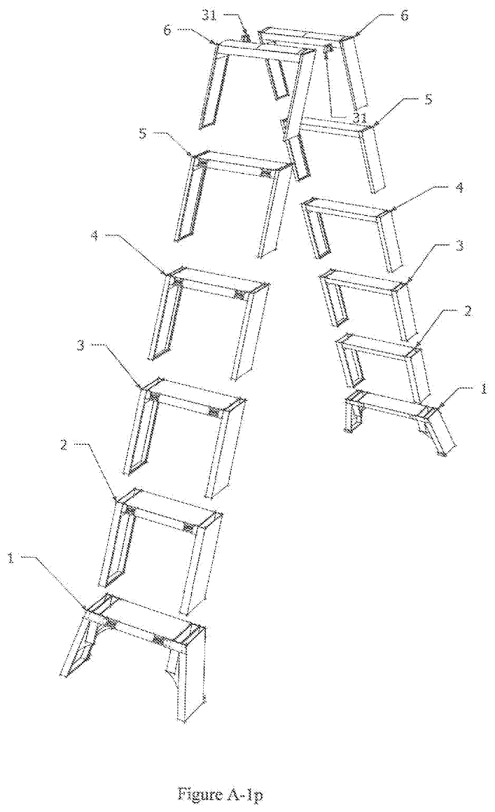

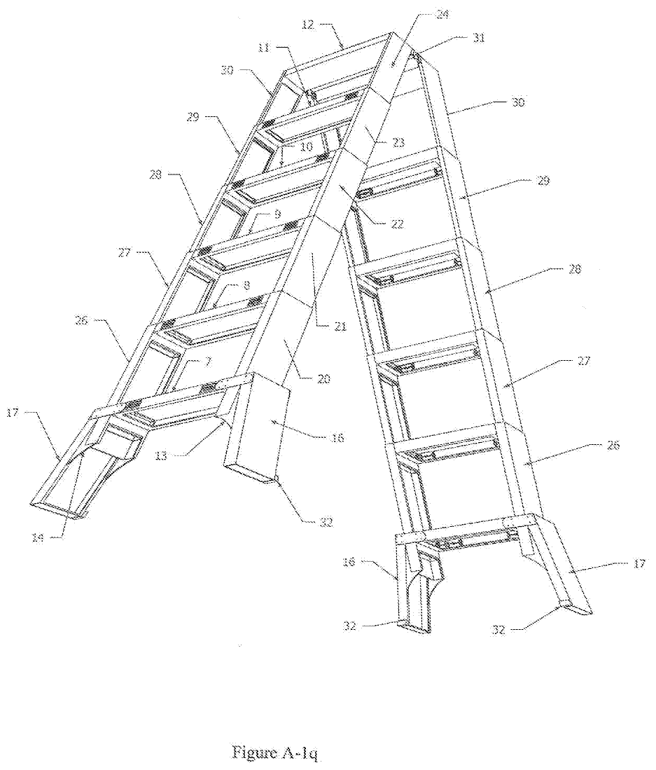

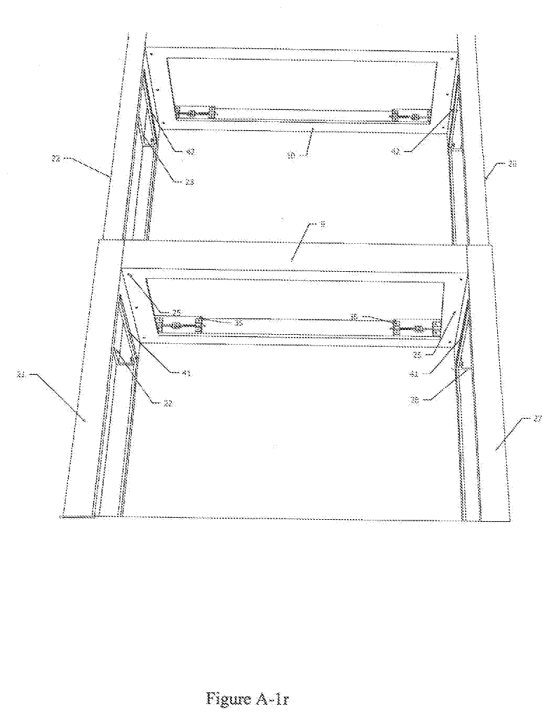

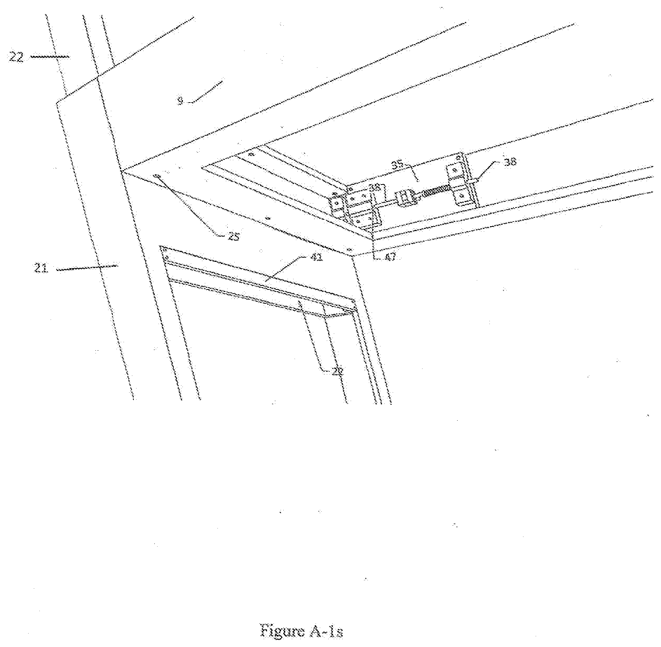

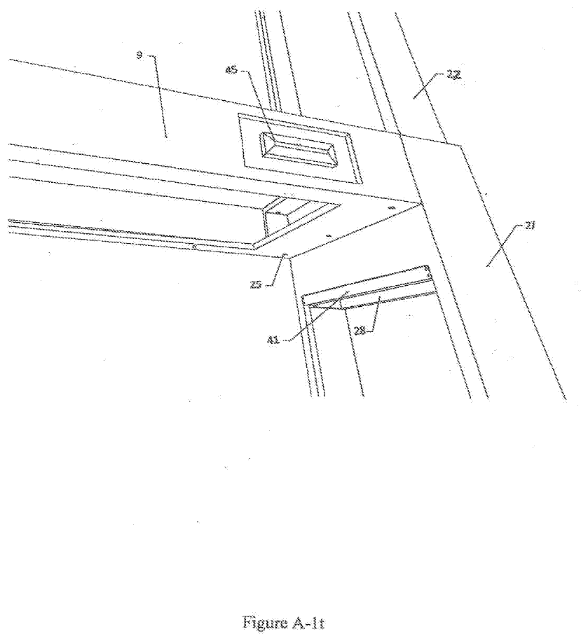

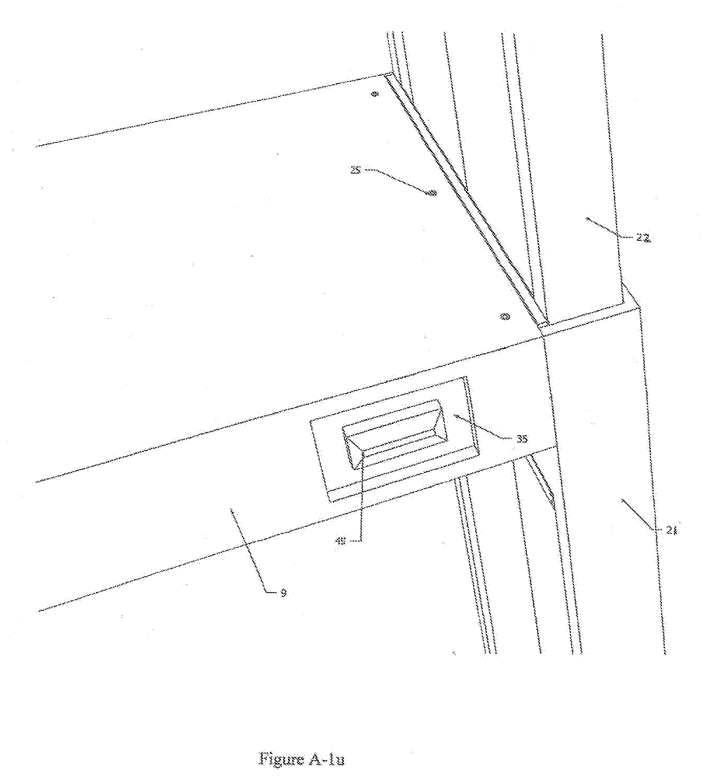

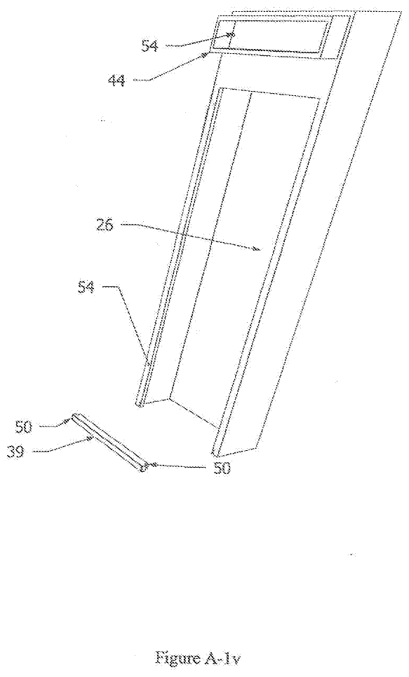

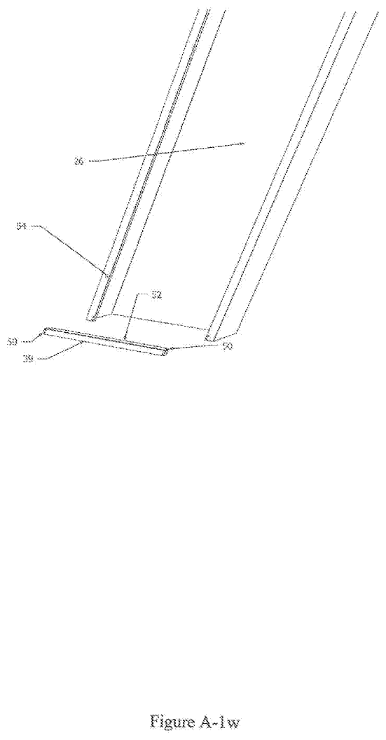

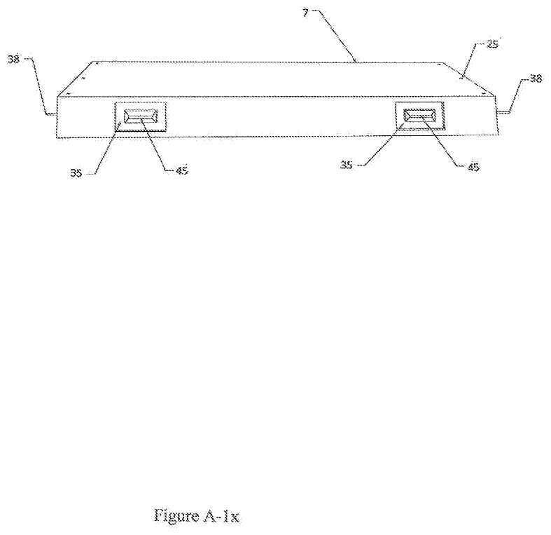

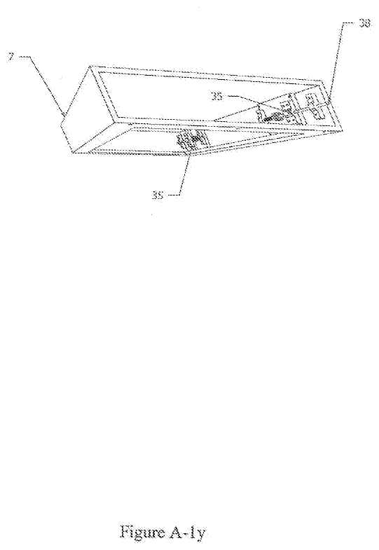

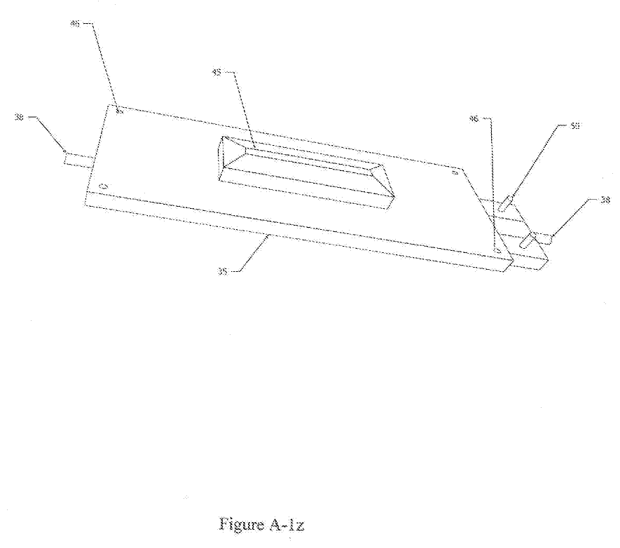

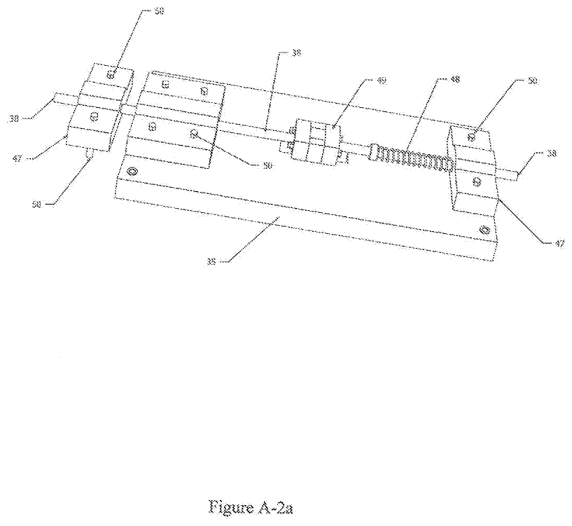

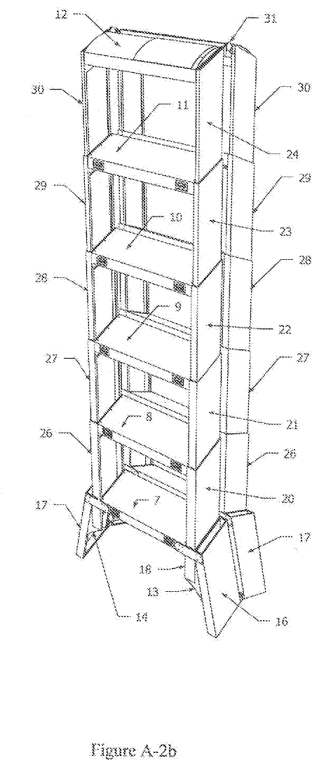

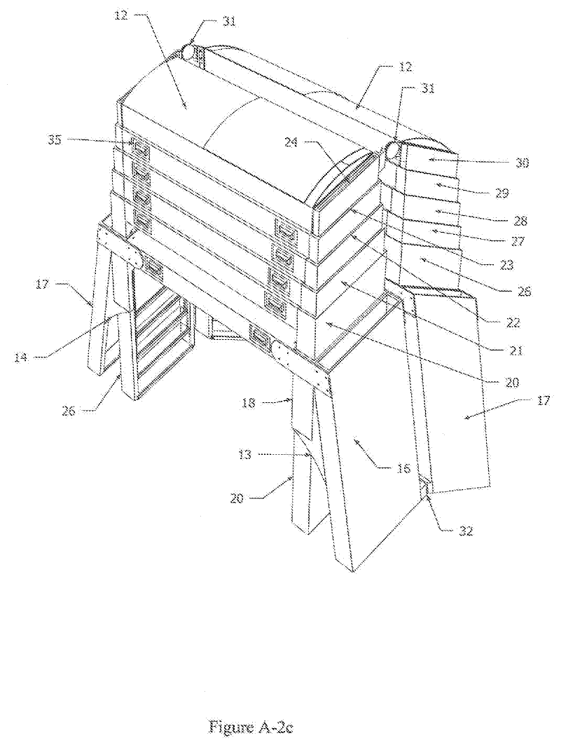

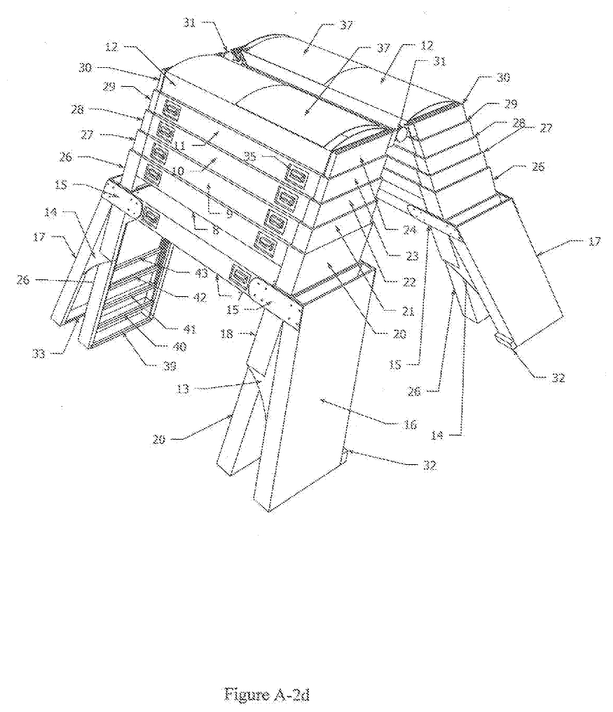

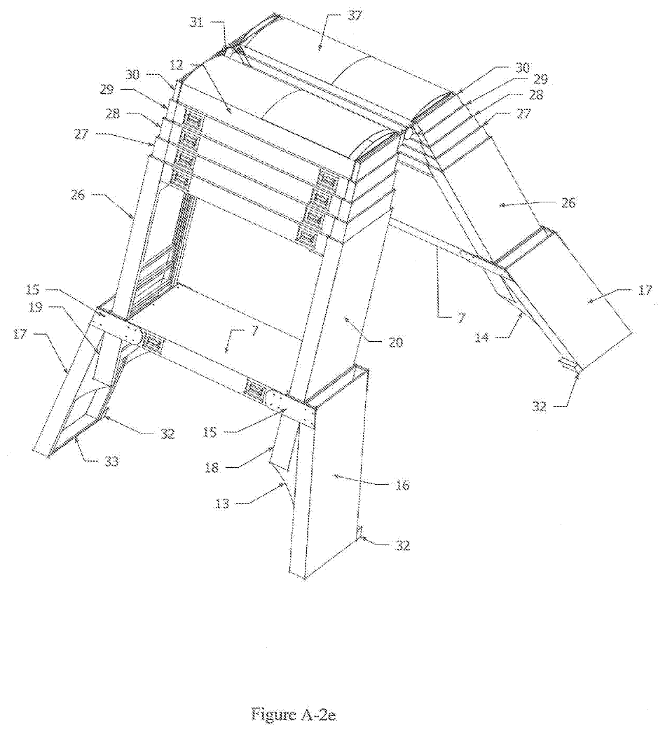

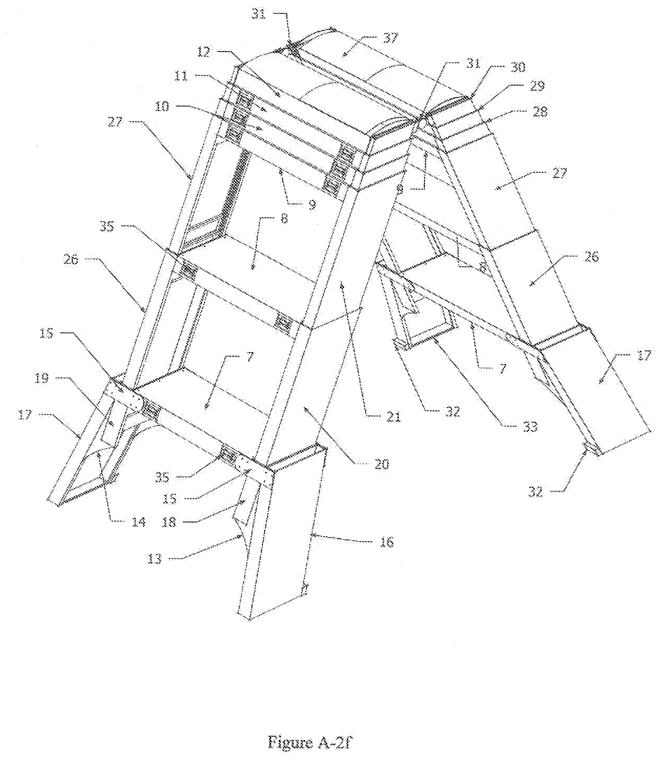

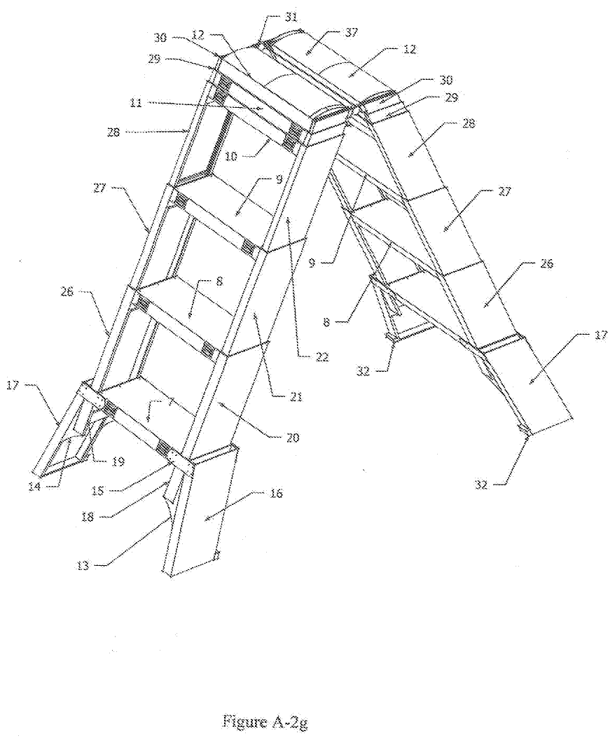

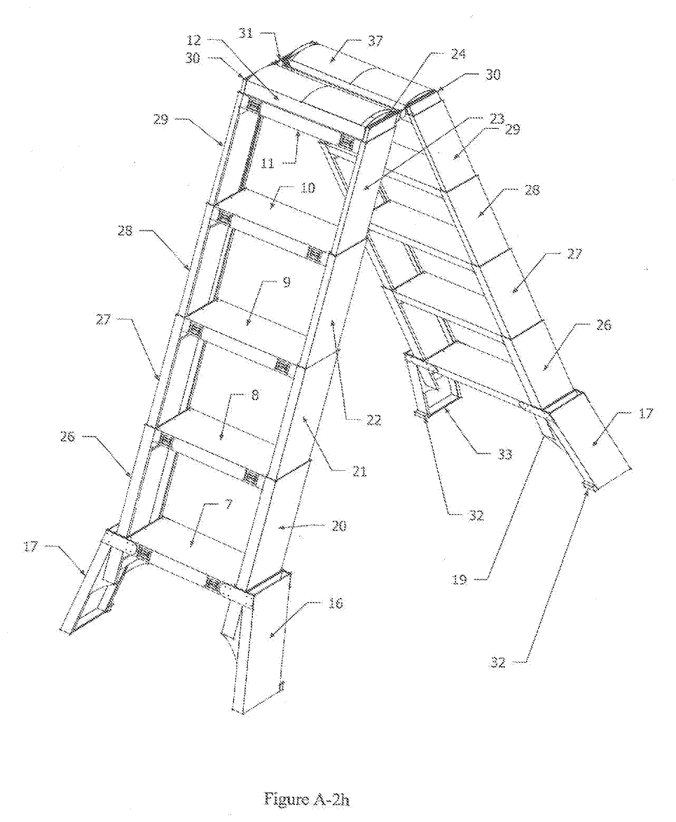

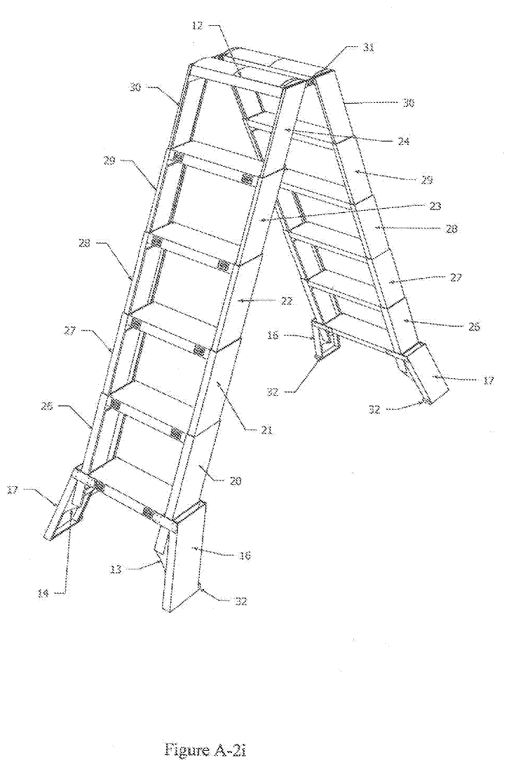

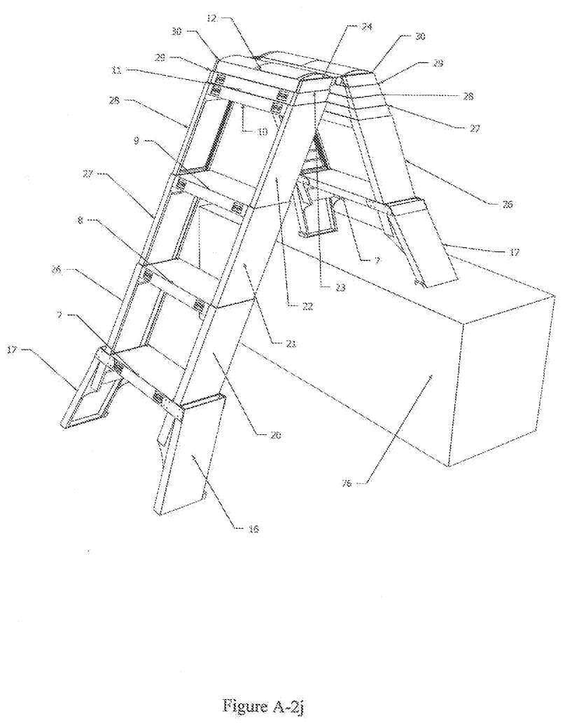

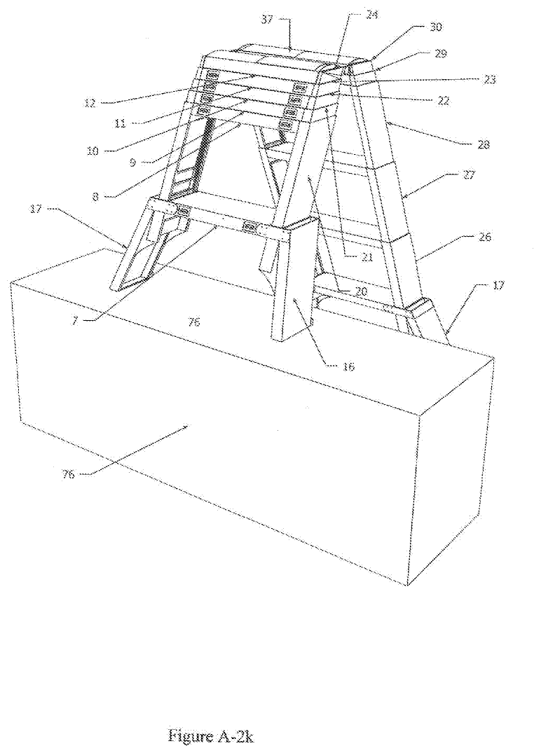

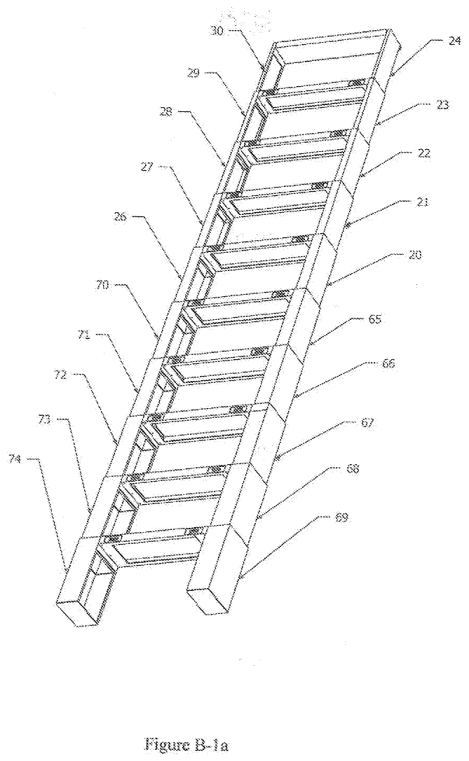

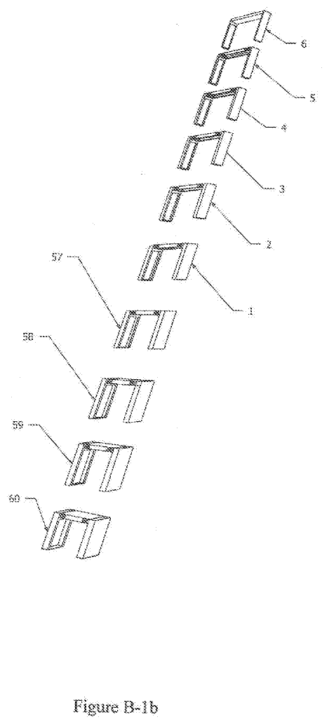

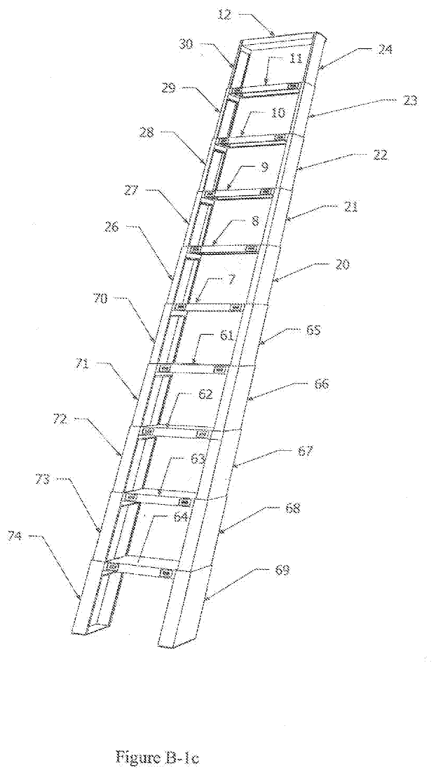

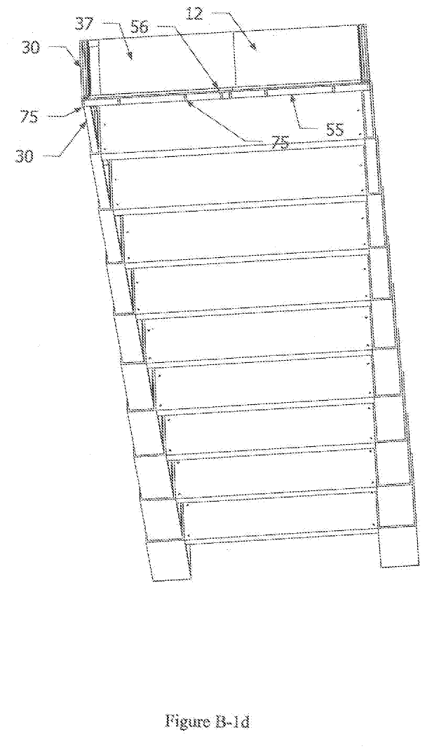

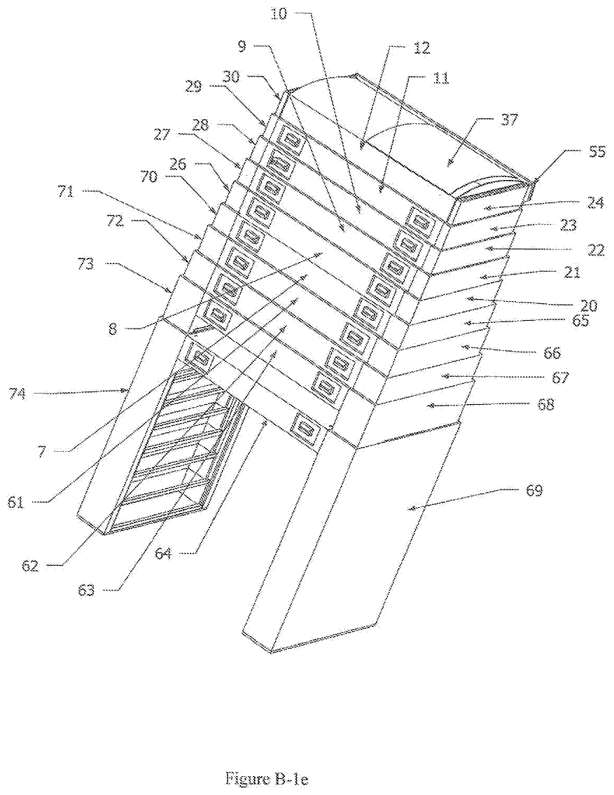

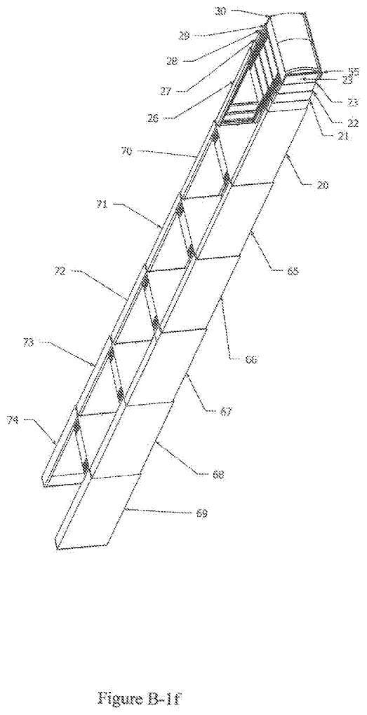

Over the years I have struggled fitting ladders in tight areas to get to an elevated work area. This has motivated me to create a true folding ladder system, where all of the step level are moveable and it will enables a full size ladder to be folded into a fraction of its original size. My folding six foot ladder can be fitted in to a small suitcase which enhance its maneuverability in very tight areas.

I have worked in the construction industry for over a decade installing fabric wall panels, window blinds and window shades. Sometimes an installation can be three feet tall on the lower end or thirty feet tall on the higher end. With such varying height it was very challenge for us to make sure that we had the right ladder for each job.

We had a variety of step ladders which ranges from 4′ to 12′ and straight ladders 18′ to 22′. For taller projects scaffolding or lift would be used. There were not enough space in our work van to carry all these ladders on every job site, so ladders would be determine according to the work order. Sometimes a ladder chosen for a particular job may not be ideal because of missing information. Our panel system may start at chair rail instead of at floor level, which is a thirty inch difference and therefore ladders chosen would not be tall enough for this job.

Sometimes to get to our work area can also be very challenging because there might be limited space to maneuver a tall ladder. We would use two people to carry one ladder, with one person at each end of the ladder. Once in a while that would not work either, because the ladder that is required for that particular job was unable to make a tight corner or pass through a narrow passage.

Folding Step Ladders that are currently on the market, at best, may fold to about sixty percent of their original size which may still be problematic for really tight areas.

My Folding Ladder System is a true square edge, folding ladder that folds at every step level and therefore when closed or folded is about a quarter (¼) of its original height. A six foot ladder when folded would be about twenty inches tall. That is twice as much as other Ladders out there. For taller ladders above six feet, as they get taller they fold smaller in proportion to their size.

### SUMMARY OF THE INVENTION

My Folding Ladder System is comprise of a folding Double Sided Folding Step Ladder (DSFSL) and a taller Straight Folding Ladder (SFL). Both ladders fold at each step level and each step level is a fraction smaller than the step level or Section that it sits on. This allows the said Step level a tight fitting overlap which create a stock up effect that allows the ladder to fold on itself, to a fraction of its original size.

This Folding Ladder System (FLS) in appearance looks like a traditional ladder. The edges are square and there are no cylindrical tubing. Uprights which are the legs of each Section adjoin together to form the legs of the ladder. Square edges are folded in such a way that a bigger Uprights rap around the smaller Uprights of an adjoined Sections and hold them in place. This creates a tight fitting channel where the smaller Uprights are able to move up and down the larger Uprights. This action creates the opening and closing effect of each Section. Except the Bottom Section all Uprights overlap about three inches. This overlap creates a firm and sturdy connection between Sections when the ladder is fully extended. With the tight fitting channel of the Uprights of each Section and with multiple Sections linked together they together form a ladder. The process can be repeated over and over until the desired length ladder is formed. Up and down movements of the Sections create the opening and closing effect of the ladder.

The DSFSL which folds at each step level is a true folding step ladder. The Bottom Section or Section 1 has Angled Uprights which prevents side tip over and is the only step level that is exactly twelve inches long. Because of the angle of the Angled Uprights a Short Channel aligned with the straight Uprights had to be created to connect the Uprights of Section 2 and a passage to the other Uprights when the ladder is folded. This Short Channel is connected to Section 2 by a three inch overlap of the #1 Uprights.

The SFL also folds at each step level and a 12′ Straight Folding Ladder which is equivalent to 144″ tall, when closed folds to 32″ which is just about a fifth (⅕) of its original height. Apart from steps on both sides of the DSFSL the main difference between both Ladders are, the Angled Uprights or Short Channels. There are no Angled Uprights on the SFL so therefore there is no need for Short Channels either. Because the Bottom Section of the SFL has regular Uprights which is aligned with #9 Upright, it is able to connect directly to the said Upright which link Section 2 and accommodate the other Uprights.

### BRIEF DESCRIPTION OF DRAWINGS

The following specifications are listed as Figure A and B where The Double Sided Folding Step Ladder is listed in Figure “As” and The Straight Folding Ladder is listed in Figure “Bs”.

FIG. A-1a is a completed and fully assembled diagonal view of a fully opened six foot DSFSL.

FIG. A-1b shows all the major parts of the DSFSL with separated Sections arranged in order as to form a complete six foot Ladder.

FIG. A-1c is a close up view showing separated and arranged parts in order as to form the right section of Section 1.

FIG. A-1d is a close up view showing separated and arranged parts in order as to form the left section of Section 1.

FIG. A-1e is a close up front view of a fully assembled Section 1. This picture shows all the connected parts of the Bottom Section.

FIG. A-1f is a close up view of Section 2 showing separated and arranged parts in order.

FIG. A-1g is a close up front view of a fully assembled Section 2. Section 2 to Section 5 are similar in appearance but each Section is slightly different in size

FIG. A-1h is a close up view of Section 3 showing separated and arranged parts in order.

FIG. A-1i is a close up front view of a fully assembled Section 3. Section 3 is similar in appearance to Section 2, Section 4 and Section 5.

FIG. A-1j is a close up view of Section 4 showing separated and arranged parts in order.

FIG. A-1k is a close up front view of a fully assembled Section 4. The operational process among the Sections, from Section 2 to Section 6 are the same.

FIG. A-1l is a close up view of Section 5 showing separated and arranged parts in order.

FIG. A-1m is a close up front view of a fully assembled Section 5.

FIG. A-1n is a close up view of Section 6 showing separated and arranged parts in order.

FIG. A-1o is a close up front view of a fully assembled Section 6.

FIG. A-1p shows separated sections from Section 1 to Section 6

FIG. A-1q shows a fully opened six foot Ladder viewed from below.

FIG. A-1r is a close up rear view of Section 3 and Section 4. Section 3 and Section 4 are fully extended and are in an opened position.

FIG. A-1s is a close up rear view of the right area of Section 3, which appears on the left from this view.

FIG. A-1t is a close up front view of the right area of Section 3 viewed from below the step level.

FIG. A-1u is a close up front view of the right area of Section 3 viewed from above the step level.

FIG. A-1v is a view of the #1 Left Upright and a disconnected #1 Leg Stop Bar.

FIG. A-1w is a close up view of the lower area of the #1 Left Upright and a disconnected #1 Leg Stop Bar.

FIG. A-1x is a front view of a separated step level, the Bottom Step, showing Pins on the sides and both Switches located at the front.

FIG. A-1y is a side, partial rear view of a separated step level, the Bottom Step, showing the Pin location at the back of the Switch.

FIG. A-1z is a close up front view of the Switch

FIG. A-2a is a close up rear view of the Switch.

FIG. A-2b is a diagonal view of a fully extended DSFSL with closed legs.

FIG. A-2c is a diagonal view of a closed DSFSL with closed legs.

FIG. A-2d is a diagonal view of a closed DSFSL with opened legs.

FIG. A-2e shows a DSFSL with open legs and an opened Section 2 while Section 3 to Section 6 are closed.

FIG. A-2f shows a DSFSL with open legs, an opened Section 2 and Section 3 while Section 4 to Section 6 are closed.

FIG. A-2g shows a DSFSL with open legs, an opened Section 2, Section 3 and Section 4 while Section 5 and Section 6 are closed.

FIG. A-2h shows a DSFSL with open legs, an opened Section 2, Section 3, Section 4 and Section 5 while Section 6 is closed.

FIG. A-2i shows a DSFSL at fully capacity with open legs and all sections fully opened.

FIG. A-2j shows a DSFSL with open Sides and each Sides of the Ladder partially open to different heights with the far Side on a Platform.

FIG. A-2k shows a DSFSL with open Sides and each Sides of the Ladder partially open to different heights with the near Side on a Platform.

FIG. B-1a is a front view from below of a fully opened ten foot SFL.

FIG. B-1b shows separated Sections of a ten foot SFL arranged in order.

FIG. B-1c is a front view at eye level of a fully opened ten foot SFL.

FIG. B-1d is a rear view from above of a fully opened ten foot SFL.

FIG. B-1e shows a ten foot SFL with all the Sections in a close position.

FIG. B1f shows a ten foot SFL partially opened with some of the Sections opened and some closed.

### DESCRIPTION OF THE INVENTION

The disclosed invention, the Folding Ladder System (FLS) is comprised of a Double Sided Folding Step Ladder (DSFSL) and a single sided Straight Folding Ladder (SFL). The DSFSIL and the SFL are both folding, collapsible ladders that fold at each step level and therefore both Ladders fold to a fraction of their original size. With this tight fold it makes transportation easy and maneuverability in tight places is no longer a problem. Both Ladders fold from within, they collapse on themselves and with each step level a fraction smaller than the step level or Section that it sits on, allows the said Step level a tight fitting channel where the Section on top slides into the Section below and this creates a stock up effect when the Ladder is closed. It's like piling each Section on top of each other where each Section fits almost completely into the Section below. When all the Sections are fitted tightly together they stock up on one another and only the Bottom Section, the outer edges of each Step, and the Top Compartment would be visible. With this stock up from within the Ladder is now in the closed position and is a fraction of its extended or original size.

When the Sections are compressed tightly together they generate the closing effect where at this time the Ladder is at its minimum and is now closed but on the contrary when the said Sections are barely touching, only connected by the overlap, it reaches its maximum and is transformed into a full size Ladder. With just an inward pull of the Switches on each Step, from the bottom where each Section is open one by one all the way to the top, the Ladder is transformed from a miniature state to its maximum size. When all the Sections of the Ladder are at their maximum each Section is connected by a three inch overlap. The three inch overlap is hidden and is at the bottom of the Section. The overlap starts at the top of each Step level and protrude three inches down. When all the Sections are fully extended the overlap which is at each joint from the Bottom Step to the Fifth Step connect the Sections together and create a sturdy and secure structure.

Both Ladders can be open to different sizes according to the job at hand and the DSFSL can even go further where each side folds to offsetting heights. If the surface is uneven, or if there is a barrier in the way the DSFSL can be adjusted to offset the difference. Both Ladders can be transformed from a one foot Ladder all the way to the full length of the Ladder.

FIG. A-1a: This illustration of the Double Sided Folding Step Ladder (DSFSL) shows it fully open and all the Sections are extended to their maximum capacity. Sections are adjoined together and the connected Uprights combine to form the Legs of the Ladder. At each Step Level there are joints where there are overlaps, but when the Ladder is fully opened they are hidden and the breaks are barely noticeable. The Angled Upright at the base of the Ladder are angled to prevent side tip over. The Angled Uprights are connected to the Short Channel by Straight Brackets at top and in the lower area by Leg Braces which allow the Angled Upright to maintain its angled slope. The Bottom Step is connected to the Short Channel and the Angled Uprights by Straight Brackets. Step 1 to Step 5 have two switches located at the outer ends of the front side. The Short Channels are connected to the Right and Left #1 Uprights which is able to move up and down the said Channels. Right and Left #1 Uprights are connected to the horizontal Step 2 at the top and vertical Right and Left #2 Uprights. Right and Left #2 Uprights are connected to the horizontal Step 3 at the top and vertical Right and Left #3 Uprights. Right and Left #3 Uprights are connected to the horizontal Step 4 at the top and vertical Right and Left #4 Uprights. Right and Left #4 Uprights are connected to the horizontal Step 5 at the top and vertical Right and Left #5 Uprights. Right and Left #5 Uprights are connected to the horizontal Top Compartment at the top which has a sliding door on top and a storage area for tools and small parts. Both sides of the Ladder is connected by two Hinges. The rear Side and the hidden areas are mirror image of the viewable areas in this diagram.

FIG. A-1b: The parts appear to be floating as they are arranged to form a fully opened DSFSL. The outline of the Ladder shows both sides, the six Sections and both Hinges which connect the sides together. With the separation I am able to clearly label all the parts and position them to show how they appear on a fully opened ladder. There are a few parts that were not visible in FIG. A-1a that are now clearly visible from this view and they are part numbers 39, 40, 41, 42, 43 which are #1 to #5 Leg Stop Bar which are attached to the lower ends of the Uprights. Part numbers 32 and 33 which are Bump Stop and Leg Base respectively are connected to the bottom of the Angled Uprights.

FIG. A-1c: This is a front view of the right area of the Bottom Section. This illustration shows floating parts, separated and arranged to form the right side of the Bottom Section. The Bottom Step on the left has two connected Switches on the far ends of the narrow face. The Right Short Channel would then be connected to the Bottom Step, then both Right Leg Braces would be connected to the Right Short Channels. The adjoined Leg Base and Bump Stop would be connected to the base of the Right Angled Upright, then the Right Angled Upright is connected to both Right Leg Braces and at the upper tip to the Right Short Channel. Both Straight Brackets would then secure all the parts together.

FIG. A-1d: This is a front view of the left area of the Bottom Section. It shows a partial view of the Bottom Step to the far right. The Left Short Channel would then be connected to the Bottom Step, then both Left Leg Braces would be connected to the Left Short Channels. The adjoined Leg Base and Bump Stop would be connected to the base of the Left Angled Upright, then the Left Angled Upright is connected to both Left Leg Braces and at the upper tip to the Left Short Channel. Both Straight Brackets would then secure all the parts together.

FIG. A-1e: This picture shows a fully assembled and separated Bottom Section from straight in front where all the parts are connected. The Bottom Section is the only Section that does not have an overlap and therefore is the only Section that is twelve inches tall. The Bottom Step has two Switches on the narrow face and is connected to the Right and Left Short Channels. The Straight Brackets secures this connection. The Short Channels are also connected to the Right and Left Angled Upright and is held into place by the Right and Left Leg Braces and the Straight Brackets. The Leg Bases are connected to the base of the Angled Uprights and provides grip on slippery places. The Right and Left Angled Uprights prevent side tip over, Right and Left Short Channel that hold the Uprights of Section 2 in place and is a passage for all the other Uprights.

FIG. A-1f: This illustration shows separated parts of Section 2 from front view. The floating parts are, Left and Right Uprights, Second Step, 2 Switches which fit into the open slots on the Second Step, and two #1 Leg Stop Bars which is connected to the lower inside edge of the Uprights.

FIG. A-1g: A standalone Section 2 which is fifteen inches tall, is three inches taller than the space between Steps, which is twelve inched. The three inch difference is the overlap which keeps the Sections connected when a Section of the Ladder or the entire Ladder is opened. Section 2 to Section 5 are similar in appearance but they are slightly different in size. Section 2 overlap is connected to the Short Channel of the Bottom Section. The Bottom Section is twelve inches tall but because Section 2 is the first of the five Sections that are fifteen inches tall, a noticeable gap of about two inches is between the Bottom Section and Section 2 when the ladder is closed. Even though there is a gap when closed when the Ladder is opened the distance between Steps are the same twelve inches.

From left to right, the #1 Left Upright is connected to the Second Step with two Switches on the outer ends. The Second Step is then connected to the #1 Right Upright. At the lower inside corner of both Uprights are #1 Leg Stop Bar which stops each Section and prevents separation when the Ladder is opened.

FIG. A-1h: This illustration shows Section 3 which is slightly smaller than Section 2 from front with separated parts. The floating parts are, Left and Right Uprights, Third Step, two Switches which fit into the open slots on the Third Step, and two #2 Leg Stop Bars which is connected to the lower inside edge of the Uprights.

FIG. A-1i: Section 3 is a carbon copy of Section 2. Section 3 is also fifteen inches tall but slightly thinner than Section 2. From left to right, the #2 Left Upright is connected to the Third Step with two Switches on the outer ends. The Third Step is then connected to the #2 Right Upright. At the lower inside corner of both Uprights are #2 Leg Stop Bar which stops each Section and prevents separation when the Ladder is opened. This Section is similar in appearance to Section 2, Section 4 and Section 5. Even though these Sections look similar they are slightly different in size. The Uprights of Section 3 fit into the Uprights of Section 2 where the Uprights of Section 2 rap around the Uprights of Section 3 and hold them into place. Now Section 3 is able to move up and down within Section 2. When closed both Steps touch and when fully opened the overlap keep the Sections connected and at this point the #2 Leg Stop Bars of Section 3 collide with the upper inner edge of Section 2 and prevent any more upward movement.

FIG. A-1j: This illustration shows Section 4 which is slightly smaller than Section 3 from front with separated parts. The floating parts are, Left and Right Uprights, Fourth Step, two Switches which fit into the open slots on the Fourth Step, and two #3 Leg Stop Bars which is connected to the lower inside edge of the Uprights.

FIG. A-1k: This picture shows a standalone fully assembled Section 4 from straight in front where all the parts are connected. From left to right, the #3 Left Upright is connected to the Forth Step with two Switches on the outer ends. The Forth Step is then connected to the #3 Right Upright. At the lower inside corner of both Uprights are #3 Leg Stop Bar which stops each Section and prevents separation when the Ladder is opened. Section 4 is a carbon copy of Section 3 but is slightly thinner. This Section is also fifteen inches tall with the three inch overlap connected to Section 3. The operational process among the Sections from Section 2 to Section 6 are the same. Section 4 is similar in appearance to Section 2, Section 3 and Section 5. Even though these Sections look similar they are slightly different in size. The Uprights of Section 4 fit into the Uprights of Section 3. The Uprights of Section 3 rap around the Uprights of Section 4 and hold them into place. Now Section 4 is able to move up and down within Section 3. When closed both Steps touch and when fully opened the overlap keep the Sections connected and at this point the Leg Stop Bars of Section 4 collide with the upper inner edge of Section 3 and prevent any more upward movement.

FIG. A-1l: This illustration shows Section 5 which is slightly smaller than Section 4 from front with separated parts. The floating parts are, Left and Right Uprights, Fifth Step, two Switches which fit into the open slots on the Fifth Step, and two #4 Leg Stop Bars which is connected to the lower inside edge of the Uprights.

FIG. A-1m: This picture shows a standalone fully assembled Section 5 from straight in front where all the parts are connected. From left to right, the #4 Left Upright is connected to the Fifth Step with two Switches on the outer ends. The Fifth Step is then connected to the #4 Right Upright. At the lower inside corner of both Uprights are #4 Leg Stop Bar which stops each Section and prevents separation when the Ladder is opened. Section 5 is a carbon copy of Section 4 but is slightly thinner. Section 5 is similar in appearance to Section 2, Section 3 and Section 4. This Section is the smaller of the inner Sections and only Section 6 is smaller. The Uprights of Section 5 fit into the Uprights of Section 4. The Uprights of Section 4 rap around the Uprights of Section 5 and hold them into place and now Section 5 is able to move up and down within Section 4. When closed both Steps touch and when fully opened the overlap keep the Sections connected and at this point the Leg Stop Bars of Section 5 collide with the upper inner edge of Section 4 and prevent any more upward movement.

FIG. A-1n: This illustration is a front view of Section 6 with a distinct, Top Compartment. Even though the Top Compartment occupies the Sixth Step, it is not a Step. The Top Compartment is rounded which will deter anyone from standing on it. The floating parts are, Left and Right Uprights, the Top Compartment which is a storage container, Hinges that connect the two sides of the ladder, and two #5 Leg Stop Bars which is connected to the lower inside edge of the Uprights.

FIG. A-1o: This illustration shows a standalone, completed Section 6 from the front. From left to right, the #5 Left Upright is connected to the Top Compartment which has a sliding door on top. The Top Compartment is then connected to the #5 Right Upright. At the lower inside corner of both Uprights are #5 Leg Stop Bar which stops each Section and prevents separation when the Ladder is opened. Floating behind the Top Compartment are Hinges that would be connected to the far side top corner of the #5 Uprights. This Section changes the rules of the Ladder where the top Step is not a Step. On all ladders the Sixth Step, Top Compartment would be a step. I made it into a storage container with rounded top because it is never safe to stand on the top Step. I made the top with a sliding door and rounded top so that it will never be mistaken for a Step and no one would stand on it. Section 6 is similar in some ways to the other Sections but with Section 1 they are different from the inner Sections. This is the smallest of all the Sections and at fifteen inches tall as the other four upper Sections. These Hinges connect the two sides of the ladder. The Uprights of Section 6 fit into the Uprights of Section 5. The Uprights of Section 5 rap around the Uprights of Section 6 and hold them into place. Now Section 6 is able to move up and down within Section 5. When closed both Steps touch and when fully opened the overlap keep the Sections connected and at this point the Leg Stop Bars of Section 6 collide with the upper inner edge of Section 5 and prevent any more upward movement.

FIG. A-1p: This illustration shows floating Sections of a Double Sided Folding Step Ladder where if the parts were touching slightly they would form a true Double Sided Ladder. All the Section are arranged in order but separated and with a mirror image of the sides, they both formed a fully opened Ladder. The Sections are fully assembled but separated. The assembled parts are, Section 1 or Bottom Section, Section 2, Section 3, Section 4, Section 5, Section 6 or Top Section and the two Hinges which connects both sides together. Except the Bottom Section which is twelve inches tall, all the other five upper Sections are fifteen inches tall. When they are connected the five upper Sections which are taller have a three inch overlap which connect the Sections together when the Ladder is open. Each Section that hovers above a Section fits almost completely into the Section below. When all the floating parts are fit tightly together they would stock up on each other and only the Bottom Section, the outer edges of each Steps and the Top Compartment would be visible. The smaller Sections fit inside the larger Sections and with the stock up effect the Ladder is able to fold to a fraction of its original size.

FIG. A-1q: This illustration shows a Double Sided Folding Step Ladder from below, fully opened with all Sections opened and opened legs. This image is similar to the image in FIG. A-1a, but viewed from below. In this state, the Bottom Section is connected to the three inch overlap of Section 2, Section 2 is connected to the three inch overlap of Section 3, Section 3 is connected to the three inch overlap of Section 4, Section 4 is connected to the three inch overlap of Section 5, Section 5 is connected to the three inch overlap of Section 6. For a taller Ladder the process would continue until the desired length Ladder is achieved. With the extended Sections, the three inch overlap from the Bottom Step to the Fifth Step hold the Sections together and create a sturdy and secure Ladder. This illustration also shows a clear view of the Angled Uprights of the Bottom Section, connected to the Short Channel and the Bottom Step on both sides.

FIG. A-1r: From this view the back of the Switches are visible with the exposed Pins which secure each Step in place. This illustration shows two opened Sections, Section 2 and Section 4 viewed from between the sides of the Ladder which shows the rear angle of both Sections. Starting from the bottom left the opened #2 Right Upright is connected to the third Step and #3 Right Upright. On the upper inside of the #2 Right Upright the #3 Leg Stop Bar is resting against it and also visible in the same area is the bottom section of #3 Right Upright inside the channel of #2 Right Upright. Going further up the process is repeated this time with #3 Right Upright, Fourth Step, #4 Right Upright and #4 Leg Stop Bar. The left side which is on the right is a mirror image or the right. Switches located inside the Steps with the back side exposed. The Pin runs across the back of the Switch and is connected to the Switch Handle through a hole in the center of the Switch. The Leg Stop Bars are in the upper most position where they collide with the upper inner section of the Uprights and prevent further upward movement of the Sections. From the bottom of the Leg Stop Bar to the top of the Step is the three inch overlap which keeps the Sections connected when the Sections are open. If there were no Leg Stop Bar and with further upward movement the Sections would separate and the Ladder would fall apart. The Leg Stop Bar secure the three inch overlap and provides sturdiness to the Ladder

FIG. A-1s: This is a close up rear view of the connection point of two Sections. The #2 Right Upright is connected to the horizontal Third Step and #3 Right Upright. The #3 Right Upright sits inside the upper channel of #2 Right Upright with an attached #3 Leg Stop Bar. The Leg Stop Bar is connected to the lower inside end of the #3 Right Upright of Section 4 and is in the upper most position. At this point the Leg Stop Bar collides with the upper inside edge of the #2 Right Upright of Section 3 and upward movement of Section 4 ends. A much clearer view of the back side of the Switch is evident showing the Pin and the connections which hold it in place. Also visible from this view are rivets which hold the Upright and the Step together.

FIG. A-1t: This is the same corner area of the Ladder in FIG. A-1s but viewed from the front. In this picture is a close up view of the front of the Switch. The #3 Leg Stop Bar of #3 Right Upright of Section 4 is resting against the upper area of the #2 Right Upright from Section 3. The Leg Stop Bar is in the most upper position now and Section 4 can slide down the inner channel of #2 Right Upright from Section 3 to close that Section.

FIG. A-1u: This is the same area as in FIG. A-1t but viewed from above. The Switch and the upper Rivets which connect the #2 Right Upright and the Third Step are visible from this view. This view also shows the relationship between Section 3 and Section 4. The #3 Right Upright of Section 4 fits tightly in the channel of the #2 Right Upright from Section 3. Section 4 is able to glide twelve inches up and down, from open to close along the channel of Section 3.

FIG. A-1v: This illustration is a #1 Left Upright and a separated #1 Leg Stop Bar from Section 2. The separated Leg Stop Bar is aligned and would be connected to the lower inside end of the Upright. The upper Pin Hole (#54) hold and lock the Pin in place when the Section is open and the lower Pin Hole (#54) secure the Pin in place when the Ladder is in a close Position. The Step Support protrude out about three inched and is perpendicular to the Upright and also aligned with the Step. The Step wraps tightly around the Step Support and is secured by Rivets.

FIG. A-1w: This is a close up view of the lower section in FIG. A-lv. The separated Leg Stop Bar would be secured by bolts to the Upright. The edges of the narrow front sides of the Upright are bent at ninety degree which form lips that interlock and secure the inner Uprights.

FIG. A-1x: This is a front view of a Step that has been separated from the Uprights. At both ends of the Step there are small tips of the Pins which protrude out which enables them to reach and fit into the upper and lower holes of the adjoin Uprights. Both Switches Handles are connected to the Pin in the rear and with an inward pull that is tensioned by the Springs, the Pins recedes and the Step is free to moves up or down. Pin locks will lock into place when it reaches the next hole. Upper Rivets holes on top of the Step are noticeable that connect the Step to the Uprights.

FIG. A-1y: this is a side view of the Step with no Upright attached. From this view, the inside of the Step is visible, showing the rear view location of the Switches. The Pin stretches the full length of the Switch and over laps on both side.

FIG. A-1z: This illustration is a close up, front view of a fully assembled Switch which has been separated from the Step. The Switch Handle is in the center of the Switch and is able to move horizontally. Portions of the Pin, the overlapping tips, are visible from this view even though it is located in the back of the Switch and runs the full length. The Pin is attached to the inside of the Switch Handel and are locked together. If the Handle is pulled to the left the Pin moves to the left and if pulled to the right they both move to the right and this horizontal movement allows the Pin to lock in and out of the Pin Hole. The rest of the Switch is stationary and is secure in place by Rivets.

FIG. A-2a: this illustration shows a much clearer rear view of the Pin which runs the full length of the Switch. It shows the connection point to the Switch Handle at the Handle Connector in the middle of the Switch. A Spring is wrapped around the Pin on the right side and is against the Pin Stabilizer Bar on one side. The Spring allows the Pin to always be in an extended position and if it is pulled back as soon as the pressure is released it pops back into position. The Pin Stabilizer Bar on the left is separated from the Switch and is also connected by the Pin. This said Stabilizer Bar is attached directly to the inside of the Step Support. Four rivets connects the Switch to the inside of the Step.

FIG. A-2b: In this illustration, it shows the two sides of the Ladder standing with all Sections opened. The unseen two sides are mirror images of these sides being viewed. All the Sections of the Ladder are fully extended and the Ladder is at full length but both legs are closed. The Bottom Section is connected at the Short Channels to the #1 Uprights of Section 2. Section 2 is connected at the #1 Uprights to #2 Upright of Section 3. Section 3 is connected at the #2 Uprights to #3 Upright of Section 4. Section 4 is connected at the #3 Uprights to #4 Upright of Section 5. Section 5 is connected at the #4 Uprights to #5 Upright of Section 6. When the Ladder is in this state, it is either being extended to a desired height, then both Sides would be open when the desired height is reached. One would extend the Ladder to a desired height with the legs closed and when the height is reached the legs of the Ladder can now be opened.

FIG. A-2c: In this illustration shows two sides of the Ladder in a closed position. The unseen sides are mirror image of the viewable sides in this image. The Ladder is at rest in this position where all the Sections and the Sides are closed. All the Uprights of the upper Sections are housed by the Short Channel of the Bottom Section. Also noticeable is the size of each Section gets smaller from bottom to top, almost like a like a step pyramid. In this state the Ladder is not suitable for usage. At this size the Ladder is at its smallest. Except for the Bottom Step and the Second Step, where there is a gap, all the other Steps are touching and the Ladder is now a fraction of its full length. It is able to be stored is small spaces, and is able to be maneuver and transport with ease.

FIG. A-2d: In this illustration shows two sides of the Ladder with all Sections closed and open Sides. The unseen sides are mirror image of the viewable sides in this image. This image is similar to the image in FIG. A-2c but the Sides of the Ladder are open. The interlocking Uprights are secured and held into place by the Short Channel as they extend below. In this state the Ladder is not suitable for standing on but it can be used as a part of a table.

FIG. A-2e: This illustration shows two sides of the Ladder standing with Section 2 opened. The unseen sides are mirror image of the viewable sides in this image. This Ladder has one Section opened and therefore this is now a One Foot Ladder. Only the Bottom Step is accessible at this time while all the other Steps are at rest. At this height on will be able to reach one foot higher at this level.

FIG. A-2f: This illustration shows the Ladder standing with Sections 2 and 3 opened. The unseen sides are mirror images of the viewable sides in this image. This Ladder has two Sections opened and therefore this is now a Two Foot Ladder. At this height one will be able to reach two feet higher. The Bottom Step and Second Step are accessible at this time while the upper Steps are at rest. In this picture only the #1 Uprights of Section 2 which is connected directly to the Short Channel is in the area of the Short Channel. All the other Uprights have now cleared the Short Channel.

FIG. A-2g: This illustration shows the Ladder standing with Sections 2, 3 and 4 opened. The unseen sides are mirror images of the viewable sides in this image. The Bottom Step, Second Step and the Third Step are accessible at this time while the upper Steps are at rest. The Ladder is now a Three Foot Ladder and one will be able to reach three feet higher. In this picture the Short Channel and the #1 Uprights of Section 2 are cleared of all Uprights but the connecting Uprights which touch them directly.

FIG. A-2h: This illustration shows the Ladder standing with Sections 2, 3, 4 and 5 opened. The unseen sides are mirror images of the viewable sides in this image. The Bottom Step, Second Step, the Third Step and Step 4 are accessible at this time while the upper Steps remain closed. This is now a Four Feet Ladder and one will be able to reach four feet higher. In this picture the Short Channel, the Uprights of Section 2 and 3 are cleared of all Uprights but the connecting Upright which touch them directly.

FIG. A-2i: This illustration shows the Ladder standing with all Sections opened. The unseen sides are mirror image of the viewable sides in this image. The Ladder is fully extended at this time where all the Sections and the Sides are opened. The Bottom Section is connected at the Short Channels to the #1 Uprights of Section 2. Section 2 is connected at the #1 Uprights to #2 Upright of Section 3. Section 3 is connected at the #2 Uprights to #3 Upright of Section 4. Section 4 is connected at the #3 Uprights to #4 Upright of Section 5. Section 5 is connected at the #4 Uprights to #5 Upright of Section 6. All the Step levels except the Top Compartment are accessible for standing at this point. The Top Compartment is never available for standing, only for storage of small tools, therefore one would be able to reach five feet higher on this Six foot Ladder. In this picture the Short Channel and all the Uprights of the Sections are cleared of all Uprights but the connecting Upright which they touch directly with a three inch overlap.

FIG. A-2j: This illustration shows the Ladder with one Side of the Ladder with three Steps opened and the leg is placed on the floor, while the other Side of the Ladder with one Step opened is resting on a Platform. This Ladder shows its versatility where the Sides can be open to different length to offset unevenness whenever the surface is at different heights. The Sections that are unopened usually have touching Steps.

FIG. A-2k: This illustration is similar to diagram in FIG. A-2j but is viewed from the opposite side. The shorter Side is placed on top of the Platform in the front with only one Step level opened. The unopened Sections show four Steps and the Top Compartment all together. In the back the taller of the Sides are partially opened with three Step levels accessible. One Side of the Ladder is a One Foot Ladder and the other a Three Foot Ladder. The offsetting difference is two feet.

FIG. B-1a: this illustration shows a fully opened ten foot Straight Folding Ladder from below with all straight Uprights. This Ladder has no angled Upright, all Uprights are straight. This Ladder does not need Angled Uprights because when open folly or even partially it needs a solid surface to rest against and also a solid platform which makes it very stable. Side tip over will not be an issue. If the SFL is put side by side with one of the Sides of the DSFSL, they would look identical. But for the Bottom Section of the DSFSL with Angled Uprights and a Short Channel, everything else is almost identical. This Ladder shows Right and Left #10 vertical Uprights connected to Right and Left #9 vertical Uprights and a horizontal Step with two Switches at the far ends at the front. This Ladder shows Right and Left #9 vertical Uprights connected to Right and Left #8 vertical Uprights and a horizontal Step with two Switches at the far ends at the front. This Ladder shows Right and Left #8 vertical Uprights connected to Right and Left #7 vertical Uprights and a horizontal Step with two Switches at the far ends at the front. This Ladder shows Right and Left #7 vertical Uprights connected to Right and Left #1 vertical Uprights and a horizontal Step with two Switches at the far ends at the front. This Ladder shows Right and Left #1 vertical Uprights connected to Right and Left #2 vertical Uprights and a horizontal Step with two Switches at the far ends at the front. This Ladder shows Right and Left #2 vertical Uprights connected to Right and Left #3 vertical Uprights and a horizontal Step with two Switches at the far ends at the front. This Ladder shows Right and Left #3 vertical Uprights connected to Right and Left #4 vertical Uprights and a horizontal Step with two Switches at the far ends at the front. This Ladder shows Right and Left #4 vertical Uprights connected to Right and Left #5 vertical Uprights and a horizontal Step with two Switches at the far ends at the front. This Ladder shows Right and Left #5 vertical Uprights connected to Right and Left #6 vertical Uprights and a horizontal Step with two Switches at the far ends at the front.

FIG. B-1b: All the ten floating Sections are arranged to form a ten foot Straight Folding Ladders. To increase the Ladder to a ten footer, Section 1 had to loose its Angled Upright and get straight Uprights. Section 6 is the smallest a Section can be so I was not able to build on top of it. I had to start at Section 1 and go down from there as I am able to make the Sections bigger. Apart from the Angled Uprights on the Bottom Section of the DSFSL, both Ladders are very similar. The operational process of both Ladders are identical. If all the floating Sections of this illustration were touching slightly they would form a fully opened ten foot Ladder, and if they were compressed tightly together they would form a closed ten foot Ladder which is a fraction of the size of an opened Ladder.

FIG. B-1c: This illustration shows an opened ten foot Straight Folding Ladder with all ten Sections opened. In appearance it looks very similar to the DSFSL without the Angled Uprights and a missing second Side. The Uprights together look like one straight piece with Steps attached to them but these are separate Sections. They are connected by a three inch overlaps of the Uprights which makes a sturdy Ladder. This is far from being a regular Ladder. This Ladder, the SFL, breaks and folds within at each Step level. It folds to about a quarter of the size of an opened Ladder. At such a small size this Ladder can be stored in small places, maneuver with ease and easily transported in the trunk of a car.

FIG. B-1d: This illustration is viewed from above showing the back side of the Ladder. This shows the Wall Support which is a brace that is connected to the Upright and the Top Compartment. It runs parallel to the Top Compartment and runs the full width of the ladder. The Wall Support has vertical rubber Wall Support Studs which grip on to the wall and prevent sliding or any damage to the wall. The Top Compartment is a locked storage area for small tools and parts and not a Step.

FIG. B-1e: This view shows a closed ten foot Ladder where all the Steps except the First Step and the Second Step which has a two inch gap, are all touching. When the Ladder is closed it has a step pyramid effect where the Sections get smaller from bottom to top. The SFL, breaks and folds within at each Step level and folds to about a quarter of the size of an open Ladder. At such a small size this Ladder can be stored in small places, maneuver with ease and easily transported.

FIG. B1f: In this illustration viewed from the side the Ladder is partially opened where the five lower Steps are accessible and the five upper Steps are closed. This Ladder is now a five foot Ladder. With a fold at each Step level this Ladder can be a one foot Ladder with the Bottom Step accessible to a fully opened ten foot Ladder where all the Steps are accessible.

Apart from double sides and a single side both Ladders are very similar except for the Bottom Section. The SFL has straight Uprights at the Bottom Section while the DSFSL has a wider base with Angled Uprights.

The Bottom Section, (Section 1) is the only Section without an overlap and therefore is exactly twelve inches (12″) tall. This Section of the DSFSL the Uprights are substituted by Angled Uprights, The Angled Upright is connected to the Short Channels and the Bottom Step by Brackets. The Angled Uprights does not align with the other Uprights so a Short Channel had to be created which align and connect with #1 Uprights. It provides an anchor and a tight fitting channel for the #1 Uprights of Section 2 and accommodate the passage of all Uprights from the other Sections. Although the Angled Uprights do not accommodate the Uprights it is very essential to the DSFSL. They provide a wider base which makes the ladder stable and with an angled slope they also significantly reduces side tip over.

All six foot ladders have six steps but on my six foot DSFSL there are only five steps. The top Step, (Top Compartment) is for storage only. The Top Compartment has a sliding door and rounded top that prevents anyone from standing on it. Instead of placing items on the top of a ladder which may fall and cause damage, small tools can be placed in this area. You can close it, then access your tools as you work along.

Left Uprights and Right Uprights of all Sections but Bottom Section are straight rectangular tubing with the inside, wide side portion of the tubing open from about 20% down from the top. At the bottom of the open section of the Uprights a Leg Stop Bar connect both open ends of the Upright. The open area of the Upright serve two purposes first, it reduces weight and second, it allows the Leg Stop Bar to move along the open area. Where the open area ends the Leg Stop Bar collides with the upper end of the Upright and thus end further upward movement. At this collision point, this is where a Section open to its maximum and therefore creating the opening space between the Steps when the ladder is fully opened.

From the Bottom Section up, the rectangular tubing of the Uprights reduce in size by the thickness of the tubing. The outside edge of the rectangular tubing of the Uprights on top is slightly smaller than the inside edge of the rectangular tubing below which allows the smaller rectangular tubing to fits inside the larger tubing. This process is repeated until there are enough pieces of tight fitting Uprights to form a ladder.

Right and left Uprights are connected at the upper inner section to a horizontal Step. Together the two Uprights and a Step forms a Section. Each Upright has a hole at the upper section and one on the lower section. Pins at the end of each Step lock into place the overlapping Section. When the ladder is open, the Pin locks into the upper hole of the Upright and when the ladder is folded, the Pin locks into the lower hole.

The Ladder is fully opened when all the Sections are extended. Both Ladders can also be opened to a desired height where only one, two, three, four or five compartments are opened. On uneven surfaces the DSFSL can open to offsetting height where each side of the ladder can be open to different heights to offset the difference. When all the Sections are closed, at this point the ladder is at rest and is now at its smallest size where it is easy to maneuver in tight places. Now storage and transporting only takes up minimal space.

1) A Square Edge, Folding Ladder System with separate Sections that folds independently at each step level;
A) A Square Edge Double Sided Folding Step Ladder with Angle Uprights at the Bottom Section and fold at each step level,
B) A Square Edge, Straight Folding Ladder with a single side which folds at each step level,
C) Square Edge Sections where each Step Level is a separate compartment Section,
D) Overlapping Square Tubing that reduce in size from bottom to top,
E) Interlocking Square Edge Uprights where the larger secure the smaller in place.

2) A Top Step converted into a Top Compartment which is for storage and not for standing.
A) A Top Compartment with rounded top,
B) A Top Compartment with a Sliding Door that is not suitable to stand on.

3) Angled Uprights at First Step Level;
A) The Bottom Section or the First Step Level has Angled Uprights that slope inwards which prevents side tip over,
B) Angled Uprights gives Ladder a wider base which enhance stability.
C) A Short Channel which is connected to the Angled Upright, aligns and also connects with #1 Uprights and also accommodate all Uprights through the said channel when the Ladder is closed.
